(19) United States
(12) Patent Application Publication
(10) Pub. No.: US 2015/0026522 A1
(43) Pub. Date: Jan. 22, 2015

(54) SYSTEMS AND METHODS FOR MOBILE APPLICATION A/B TESTING

(71) Applicants: Dawnray Young, Camas, WA (US); Vijay Lakshminarayanan, Beaverton, OR (US)

(72) Inventors: Dawnray Young, Camas, WA (US); Vijay Lakshminarayanan, Beaverton, OR (US)

(21) Appl. No.: 13/946,196

(22) Filed: Jul. 19, 2013

(51) Int. Cl. G06F 11/36

(52) U.S. Cl. CPC G06F 11/368
USPC 714/38.1

(57) ABSTRACT

Techniques for electing winning treatments in connection with A/B testing of mobile applications are described. According to various embodiments, the activation of a version of a mobile application installed on a mobile device may be detected. A database storing winning treatment information describing one or more winning treatments for one or more A/B tests is accessed. In some embodiments, each of the one or more A/B tests in the winning treatment information may be associated with a particular version of a particular mobile application. Thereafter, a specific winning treatment for a specific A/B test associated with the version of the mobile application installed on the mobile device may be determined, based on the winning treatment information. The specific winning treatment may then be implemented in the mobile application installed on the mobile device.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to data processing systems and, in one specific example, to techniques for electing winning treatments in connection with A/B testing of mobile applications.

### BACKGROUND

The practice of A/B testing, also known as “split testing,” is a popular method for making improvements to webpages and other online content. A/B testing typically involves preparing two versions (also known as variances or treatments) of a piece of online content, such as a webpage, a landing page, an online advertisement, and so etc., and publishing them simultaneously to separate, equally sized audiences to see which variance performs better.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed;

FIG. 2 is a block diagram of an example system, according to various embodiments;

FIG. 3 is a flowchart illustrating an example method, according to various embodiments;

FIG. 4 illustrates exemplary winning treatment information, according to various embodiments;

FIG. 5 is a flowchart illustrating an example method, according to various embodiments;

FIG. 6 illustrates an exemplary mobile device, according to various embodiments; and

FIG. 7 is a diagrammatic representation of a machine in the example form of a computer system within which a set of instructions, for causing the machine to perform any one or more of the methodologies discussed herein, may be executed.

### DETAILED DESCRIPTION

Example methods and systems for electing winning treatments in connection with A/B testing of mobile applications are described. In the following description, for purposes of explanation, numerous specific details are set forth in order to provide a thorough understanding of example embodiments. It will be evident, however, to one skilled in the art that the present invention may be practiced without these specific details.

According to various exemplary embodiments, a mobile application A/B testing system enables any mobile application or “app” installed on a mobile device to reflect the results of current mobile application A/B tests or experiments in near real-time, without having to make users wait months to download an updated version of the mobile application at the next mobile application release cycle.

For example, conventionally, a given version of a mobile application is preprogrammed or hardwired with different possible versions of features of the mobile application, where these versions may be known as “treatments” or “variances”. For example, a mobile application may be preprogrammed with different types of user interface elements or advertisements that are configured to be displayed in a user interface of the mobile device. Accordingly, A/B testing of the different preprogrammed variances may then be selectively performed on a pool of users that have this mobile application, in order to determine a “winning variance”.

More specifically, an A/B test may involve testing two different variances or treatments of some feature of an application, by publishing the variances to separate, roughly equally sized audiences to see which variance performs better. The most successful variance or treatment, as determined by the A/B test, is then referred to as the winning variance or winning treatment. For example, in order to determine whether a small advertisement or a large advertisement in a webpage displayed in a user interface receives more clicks, a first version of the webpage including the small advertisement may be displayed to a first group of people, and a second version of the webpage including the large advertisement may be displayed to a second group of people, and it may be determined which advertisement receives the most clicks over a given period of time. For example, the results of the test may indicate that the small advertisement received 100 clicks in one day, whereas the large advertisement received 4 clicks in one day. Accordingly, the second version of the webpage including the larger advertisement will be the winning treatment for this test or experiment.

Moreover, in order to perform mobile application A/B testing, a web server or service commonly referred to as an “experimentation service” typically stores information identifying which mobile devices are to participate in an A/B test, and which of these devices are to instantiate a given variance in the A/B test. Thus, mobile applications installed on mobile devices consult with the experimentation service in order to determine if they should participate in an A/B test and, if so, whether they should be providing experience on a particular treatment. This operation is usually expensive and can trigger complicated logic on the experimentation service side.

Traditionally, when an experiment ends, and if a treatment of an experiment is deemed favorable, a mobile application will be defaulted back to a state as if no experiment has been conducted. In other words, mobile A/B testing does not automatically wire the application in the field to respond to a new winning treatment of the experimentation. Instead, the winning variance as determined by the A/B test is only fully implemented in an updated version of the mobile application in the next mobile application release cycle (typically once a quarter, and usually a few months after the A/B testing is performed). Thus, users of the mobile application must typically wait several months for the revised app to become available, and must then affirmatively download the revised app in order to see those changes.

Accordingly, a mobile application A/B testing system described herein is configured to communicate with a “configuration web service” that includes a database optimized for low-expense read operations that stores the “winning variances” for a given version of a given mobile app. More specifically, the configuration service described herein may correspond to a web service or server that includes a shared database that a mobile application can read information from, where the database is optimized for high performance low-expense read operations. Thus, when a mobile app (which is hardwired with the different variances) installed on a mobile client is launched, opened, or activated, it can call the configuration web service and immediately implement the winning variance locally.

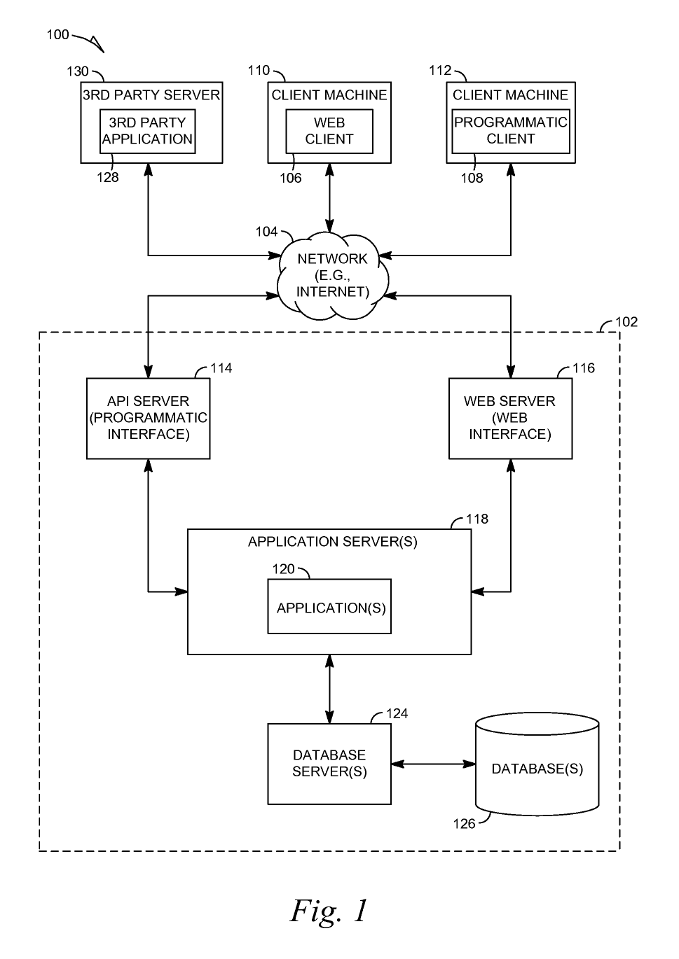

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

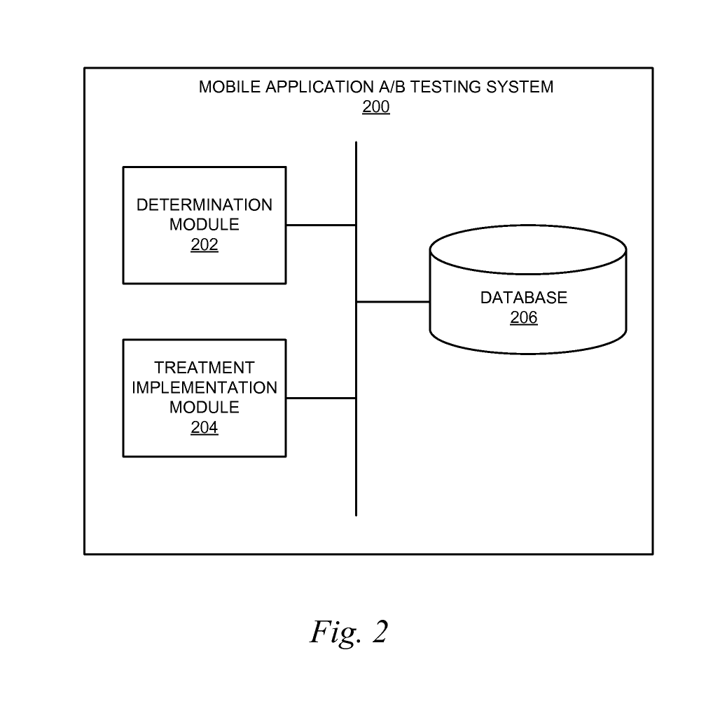

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may be implemented on or executed by one or more of the modules of the system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

Turning now to FIG. 2, in some embodiments, a mobile application A/B testing system 200 includes a determination module 202, a treatment implementation module 204, and a database 206. The modules of the mobile application A/B testing system 200 may be implemented on or executed by a single device such as a mobile application A/B testing device, or on separate devices interconnected via a network. The aforementioned mobile application A/B testing device may be, for example, one of the client machines (e.g. 110, 112) or application server(s) 118 illustrated in FIG. 1.

As described in more detail below, the determination module 202 is configured to detect that a user of a mobile device has activated a version of a mobile application installed on the mobile device. Thereafter, the determination module 202 is configured to access a database (e.g, database 206) storing winning treatment information. The winning treatment information may identify, for a given version of a given mobile application, one or more A/B tests and one more winning treatments for each of the A/B tests. The determination module 202 is then configured to determine, based on the winning treatment information, a specific winning treatment for a specific A/B test associated with the version of the mobile application installed on the mobile device. Thereafter, the treatment implementation module 204 is configured to implement the specific winning treatment in the mobile application installed on the mobile device. While various embodiments herein refer to A/B tests, it is understood that the embodiments herein are also applicable to other types of tests (e.g., multivariate tests) of mobile applications installed on mobile devices.

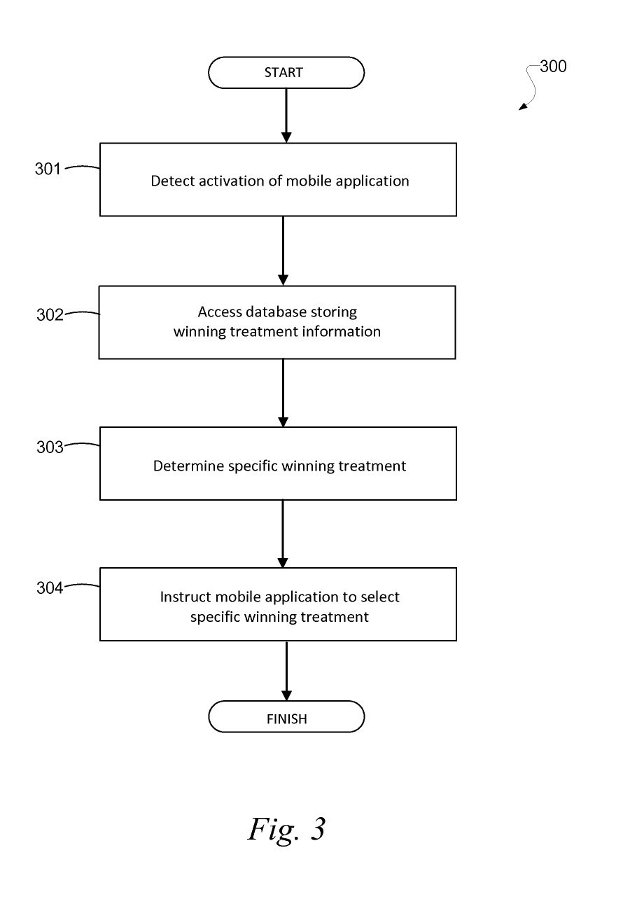

For example, FIG. 3 is a flowchart illustrating an example method 300, according to various exemplary embodiments. The method 300 may be performed at least in part by, for example, the mobile application A/B testing system 200 illustrated in FIG. 2 (or an apparatus having similar modules, such as client machines 110 and 112 or application server 118 illustrated in FIG. 1). In operation 301, the determination module 202 detects that a user of a mobile device has activated a version of a mobile application installed on the mobile device. The mobile application may be any type of application or software program installed on a mobile device, as understood by those skilled in the art. For example, the mobile application maybe a social networking mobile application provided by Facebook® or LinkedIn®, or a marketplace or retailer application provided by eBay® or Amazon®, or a financial or banking application provided by PayPal® or bank such as Chase®, or a media sharing application provided by YouTube® or Instagram®, and so on. Other examples of mobile applications are well understood by those skilled in the art. As described in more detail below, the mobile application installed on the mobile device may be pre-programmed or “hardwired” with different variances or treatments of various features of the mobile application.

In some embodiments, the determination module 202 may detect that the user has activated a given version of a given mobile application by receiving an activation detection signal transmitted by from the mobile application or a mobile operating system (or mobile OS) installed on the mobile device (e.g., Android, IOS, BlackBerry 10, Windows Phone, etc.). For example, when the mobile application or mobile OS installed on the mobile device detects that the application has been launched, activated, opened, etc., the mobile application or mobile OS may transmit a signal to the mobile application A/B testing system 200. Alternatively, the mobile application A/B testing system 200 may transmit a signal to the mobile device (or the mobile application or the mobile OS thereof) requesting whether the mobile application has been launched.

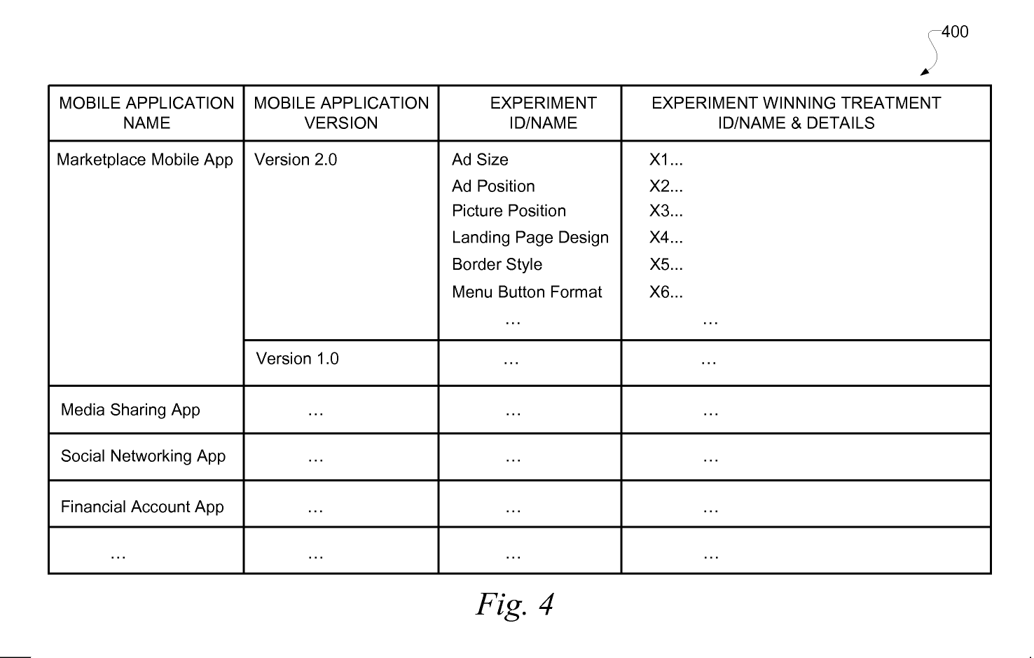

In operation 302 in FIG. 3, the determination module 202 accesses a database storing winning treatment information describing winning treatments for A/B tests. For example, FIG. 4 illustrates exemplary winning treatment information 400 identifying various mobile applications (e.g., a Marketplace Mobile App, a Media Sharing App, a Social Networking App, a Financial Account app, etc.)., and, where applicable, different available versions of such mobile applications (e.g., Version 1 and Version 2 of the Marketplace Mobile App, as illustrated in FIG. 4). For each version of each mobile application, the winning treatment information 400 identifies a test or experiment that has been performed in connection with that version of that mobile application (e.g., see experiment name/ID in FIG. 4). Further, as illustrated in FIG. 4, the winning treatment information 400 may identify or describe a winning treatment for each of the A/B tests.

For example, as illustrated in FIG. 4, for Version 2.0 of the “Marketplace Mobile Application”, the winning treatment information 400 identifies the experiment “Ad Size”, which may correspond to, for example, an A/B test of two different advertisement sizes for display in a user interface of the aforementioned Marketplace Mobile Application. The winning treatment information 400 also describes the winning treatment of the A/B test “Ad Size” by including a description “X1 . . . ” (or a reference link such as a Uniform Resource Locator (URL) for accessing a description “X1 . . . ”) of an identifier of the winning treatment or the properties (e.g., advertisement size) of the winning treatment. Similarly, the winning treatment information 400 includes description of the winning treatments for other A/B tests, such as “Ad Position”, “Picture Position”, “Landing Page Design”, and so on. Accordingly, the winning treatment information 400 described herein identifies tests performed in connection with various version of various mobile applications, as well as the winning treatment for each test.

In some embodiments, the winning treatment of an A/B test may correspond to settings, properties, parameters, characteristics, etc., of a user interface element configured to be displayed by a mobile application via a user interface. Examples of user interface elements include menus, buttons, commands, windows, pull-down menus, advertisements, backgrounds, borders, images, text, advertisements, video, rich media, user-selectable elements, and so on. Thus, the winning treatment of an A/B test may define properties associated with any type of user interface element, such as those described above. In some embodiments, the winning treatment may correspond to or describe settings, properties, parameters, characteristics, etc., of advertisements configured to be displayed by the mobile application via a user interface. For example, the winning treatment may describe the format, content, size, placement position, organization, design, color, presentation, or any other properties dealing with advertisements for display by the mobile application. A/B tests are not limited to user interface elements or advertisement displayed by mobile applications, but may also refer to any other aspect of the operation of a mobile application, such as flow experience, download and access settings, authorization settings, profile settings, financial account settings, and so on.

The winning treatment information 400 may be stored locally at, for example, the database 206 illustrated in FIG. 2, or may be stored remotely at a database, data repository, storage server, etc., that is accessible by the mobile application A/B testing system 200 via a network (e.g., the Internet). In some embodiments, the database storing the winning treatment information 400 may correspond to or include a cache optimized for low-expense read operations.

Returning to the method 300 illustrated in FIG. 3, in operation 303, the determination module 202 determines, based on the winning treatment information accessed in operation 302, a specific winning treatment for a specific A/B test associated with the version of the mobile application that was activated by the mobile device user (in operation 301). For example, if the determination module 202 determined in operation 301 that the user of the mobile device activated Version 2.0 of the “Marketplace Mobile App”, then the determination module 202 may identify one or more A/B tests (e.g., “Ad Size”, “Ad Position”, “Picture Position”, etc.) for this version of this app, and the winning treatments for each of these A/B tests, based on the winning treatment information 400.

Finally, in operation 304, the treatment implementation module 204 may implement the winning treatment(s) determined in operation 303 into the mobile application installed on the user's mobile device. For example, if the determination module 202 determined in operation 301 that the user of the mobile device activated Version 2.0 of the “Marketplace Mobile App”, then the treatment implementation module 204 may access and implement the winning treatments for the various A/B tests (e.g., “Ad Size”, “Ad Position”, “Picture Position”, etc.) for Version 2.0 of the “Marketplace Mobile App”, based on the winning treatment information 400 illustrated in FIG. 4. The treatment implementation module 204 may automatically implement the winning treatment(s) in response to the determination in operation 303.

In some embodiments, the implementing in operation 304 may comprise instructing the mobile application to select the specific winning treatment from among the plurality of candidate treatments pre-programmed into the mobile application and instructing the mobile application to perform operations based on the specific winning treatment

For example, as described above, the mobile application installed on the mobile device may be pre-programmed or “hardwired” with different treatments or variances within the source code or programming code associated with the mobile application, in order to perform mobile application A/B testing. In other words, a given version of a mobile application must be written to handle various planned experiments and treatments ahead of time, so that A/B tests of these different candidate treatments already pre-programmed into the mobile application may be performed. For example, the source code or programming code of the mobile application may include a portion of programming code (entitled “Ad Position”, for example) that defines advertisement position properties pertaining to advertisements displayed by the mobile application via a user interface, where this programming code may identify different variances (e.g., “Treatment 1”, Treatment 2″, etc.), and include programming code associated with each treatment. Accordingly, the treatment implementation module 204 may implement the winning variance by transmitting a message to the mobile application to implement “Treatment 2” for the “Ad Position” section of the code, for example.

Accordingly, the operation 304 in FIG. 3 may comprise the treatment implementation module 204 transmitting a request or instruction to the mobile application instructing the mobile application to identify and select the winning treatment from among the plurality of candidate treatments pre-programmed into the mobile application, to designate this treatment as a “winning treatment” associated with the mobile application, and to instruct the mobile application to execute, activate, implement, or enable the winning treatment, to incorporate the winning treatment into normal operations of the mobile application, or to otherwise perform operations based on the winning treatment. In some embodiments, the aforementioned instruction transmitted by the treatment implementation module 204 may instruct, request, or cause the mobile application to disable, delete, or ignore one or more of the other candidate treatments (e.g., other than the specific winning treatment) that are pre-programmed into the mobile application.

In some embodiments, the treatment implementation module 204 may implement the winning treatment by transmitting instructions directly describing the winning treatment to the appropriate mobile application. For example, if the winning treatment information 400 includes a description of various aspects of the winning treatment (e.g., Ad size=A×B), then the treatment implementation module 204 may simply transmit a message to the mobile application with a request to alter a corresponding parameter (e.g., an ‘Ad Size’ parameter) in the source code or programming code of the mobile application to “A×B”.

In some embodiments, the mobile application A/B testing system 200 described herein may be implemented on or executed by a server, such as the configuration web service described above. For example, the configuration service may receive a message from a mobile application installed on a mobile device, indicating that the mobile application has been launched. Thereafter, the configuration web service may access winning treatment information (which may be stored locally at a database of the configuration web service or remotely at a remote data repository), and the configuration web service may determine the appropriate winning treatments. Finally, the configuration web service may transmit a message to the mobile device, implementing the winning treatment on the mobile device, as described above.

In other embodiments, the mobile application A/B testing system 200 described herein may actually be implemented on or executed by the user's mobile device itself, and the mobile application A/B testing system 200 installed on the mobile device may communicate with the configuration web service in order to determine the winning treatments. For example, after the mobile application A/B testing system 200 detects the launch of a mobile application, the mobile application A/B testing system 200 may transmit a request to the configuration web service, where the request identifies a particular version of a particular mobile application that was launched on the mobile device. The configuration service may respond to the mobile application A/B testing system 200 with the appropriate winning treatment information (e.g., instructions, or a specification of a winning variance preprogrammed into the mobile application), and the mobile application A/B testing system 200 may then implement the winning treatment locally on the mobile device.

According to various exemplary embodiments, the mobile application A/B testing system 200 may be configured to generate the winning treatment information 400 described herein. For example, in some embodiments, the mobile application A/B testing system 200 may receive, acquire, or access the results of an A/B test associated with a particular version of a particular mobile application. In some embodiments, the test results may be received from a server of data store configured to store such test results, such as the experimentation web service described in other embodiments. In some embodiments, the test results may be stored locally at, for example, the database 206 illustrated in FIG. 2, or may be stored remotely at a database, data repository, storage server, etc., that is accessible by the mobile application A/B testing system 200 via a network (e.g., the Internet).

Based on the results, the mobile application A/B testing system 200 may determine the winning treatment of the A/B test, and generate and store the winning treatment information in association with the particular version of the particular mobile application in a database (e.g., database 206 illustrated in FIG. 2). Accordingly, after an experiment has ended, the mobile application A/B testing system 200 may write detailed information about the winning treatment to a configuration service database. The information on the winning treatment may contain the name of the mobile application, the version of the mobile application, the Site ID of the mobile application the experimentation ID, and name of the winning treatment ID/name and its containing details (e.g., see FIG. 4).

In some embodiments, the test results received by the mobile application A/B testing system 200 may directly indicate or describe the winning treatment of the A/B test. Alternatively, in some embodiments, the results received by the mobile application A/B testing system 200 may include the actual results of the A/B tests, such as results indicating how successful each of the test variances were in the A/B test. For example, the test results may indicate that a first variance of an advertisement received 100 clicks in one day, whereas a second variance of an advertisement received 4 clicks in one day. Based on the this information, the determination module 202 may determine that the first variance of the advertisement is the winning variance or winning treatment, and the determination module 202 may store information identifying and/or describing the first variance in the winning treatment information 400 in association with the relevant version of the relevant mobile application.

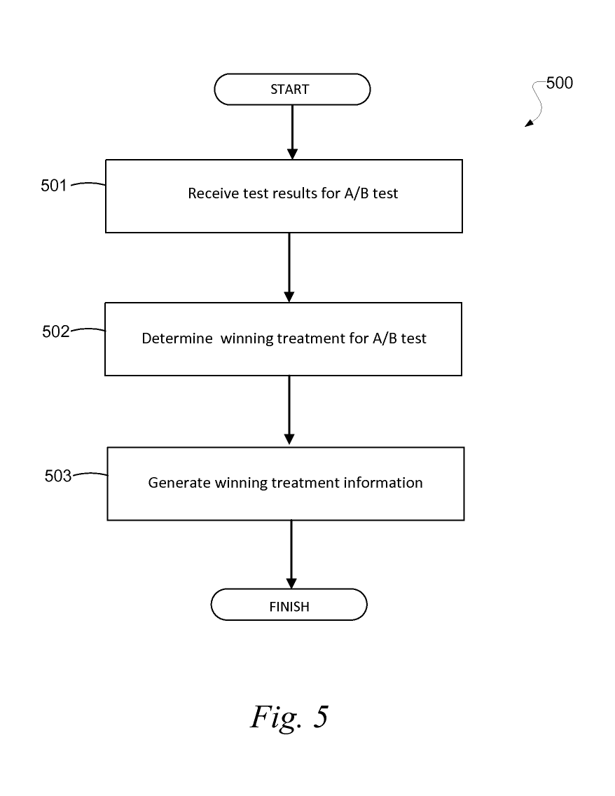

For example, FIG. 5 is a flowchart illustrating an example method 500, consistent with various embodiments described above. The method 500 may be performed at least in part by, for example, the mobile application A/B testing system 200 illustrated in FIG. 2 (or an apparatus having similar modules, such as client machines 110 and 112 or application server 118 illustrated in FIG. 1). In operation 501, the determination module 202 receives test result information associated with the specific A/B test from an experimentation web service. In operation 502, the determination module 202 determines the specific winning treatment for the specific A/B test, based on the test result information. In operation 503, the determination module 202 generates the winning treatment information describing the specific winning treatment for the specific A/B test.

### Example Mobile Device

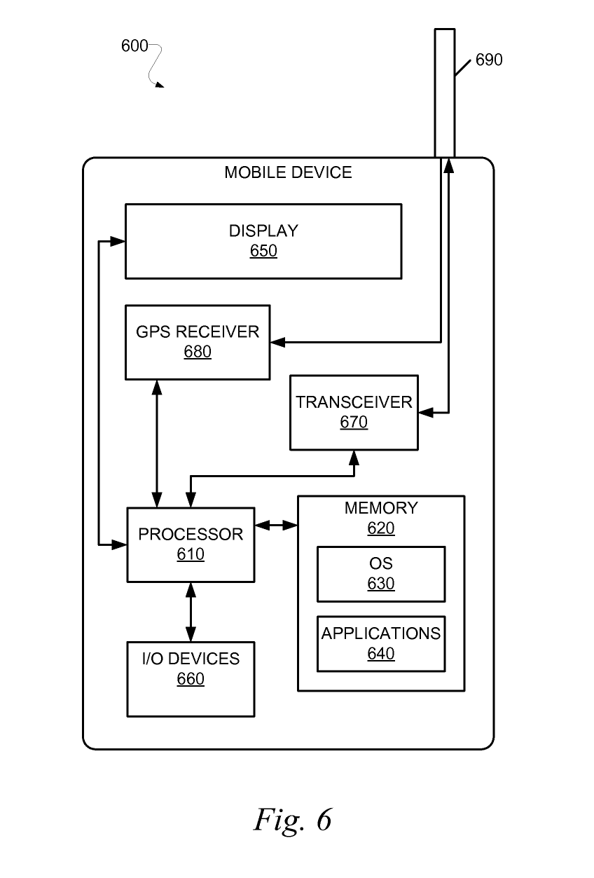

FIG. 6 is a block diagram illustrating the mobile device 600, according to an example embodiment. The mobile device may correspond to, for example, client machines 110 and 112 or application server 118 illustrated in FIG. 1. One or more of the modules of the system 200 illustrated in FIG. 2 may be implemented on or executed by the mobile device 600. The mobile device 600 may include a processor 610. The processor 610 may be any of a variety of different types of commercially available processors suitable for mobile devices (for example, an XScale architecture microprocessor, a Microprocessor without Interlocked Pipeline Stages (MIPS) architecture processor, or another type of processor). A memory 620, such as a Random Access Memory (RAM), a Flash memory, or other type of memory, is typically accessible to the processor 610. The memory 620 may be adapted to store an operating system (OS) 630, as well as application programs 640, such as a mobile location enabled application that may provide location based services to a user. The processor 610 may be coupled, either directly or via appropriate intermediary hardware, to a display 650 and to one or more input/output (I/O) devices 660, such as a keypad, a touch panel sensor, a microphone, and the like. Similarly, in some embodiments, the processor 610 may be coupled to a transceiver 670 that interfaces with an antenna 690. The transceiver 670 may be configured to both transmit and receive cellular network signals, wireless data signals, or other types of signals via the antenna 690, depending on the nature of the mobile device 600. Further, in some configurations, a GPS receiver 680 may also make use of the antenna 690 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

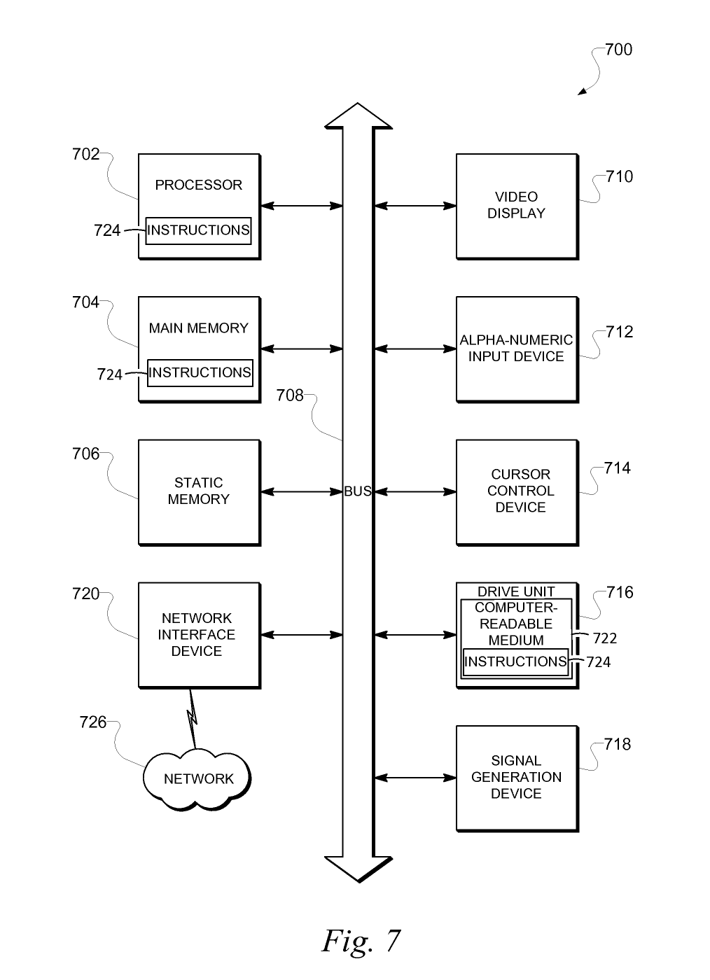

FIG. 7 is a block diagram of machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
detecting that a user of a mobile device has activated a version of a mobile application installed on the mobile device, the mobile application being pre-programmed with a plurality of candidate treatments associated with one or more features of the mobile application;
accessing a database storing winning treatment information describing one or more winning treatments for one or more A/B tests, each of the one or more A/B tests being associated with a particular version of a particular mobile application;
determining, based on the winning treatment information, a specific winning treatment for a specific A/B test associated with the version of the mobile application installed on the mobile device; and
instructing the mobile application to select the specific winning treatment from among the plurality of candidate treatments pre-programmed into the mobile application and to perform operations based on the specific winning treatment.

2. The method of claim 1, wherein the plurality of candidate treatments are pre-programmed into programming code associated with the mobile application.

3. The method of claim 2, wherein the instructing comprises:
transmitting a request to the mobile application to select the winning treatment from among the plurality of candidate treatments pre-programmed into the mobile application and to perform operations based on the winning treatment.

4. The method of claim 1, wherein the specific winning treatment describes one or more user interface element properties associated with a user interface of the mobile application.

5. The method of claim 1, wherein the specific winning treatment describes one or more advertisement format properties associated with a user interface of the mobile application.

6. The method of claim 1, further comprising:
receiving test result information associated with the specific A/B test from an experimentation web service;
determining the specific winning treatment for the specific A/B test, based on the test result information; and
generating the winning treatment information describing the specific winning treatment for the specific A/B test.

7. The method of claim 1, wherein the detecting comprises:
receiving an activation detection signal transmitted by at least one of the mobile application installed on the mobile device and a mobile operating system installed on the mobile device.

8. The method of claim 1, wherein the database includes a cache optimized for low-expense read operations.

9. An apparatus comprising:
a determination module implemented by one or more processors and configured to:
detect that a user of a mobile device has activated a version of a mobile application installed on the mobile device, the mobile application being pre-programmed with a plurality of candidate treatments associated with one or more features of the mobile application;
access a database storing winning treatment information describing one or more winning treatments for one or more A/B tests, each of the one or more A/B tests being associated with a particular version of a particular mobile application; and
determine, based on the winning treatment information, a specific winning treatment for a specific A/B test associated with the version of the mobile application installed on the mobile device; and
a treatment implementation module configured to instruct the mobile application to select the specific winning treatment from among the plurality of candidate treatments pre-programmed into the mobile application and to perform operations based on the specific winning treatment.

10. The apparatus of claim 9, wherein the plurality of candidate treatments are pre-programmed into programming code associated with the mobile application.

11. The apparatus of claim 10, wherein the treatment implementation module is further configured to:
transmit a request to the mobile application to select the winning treatment from among the plurality of candidate treatments pre-programmed into the mobile application and to perform operations based on the winning treatment.

12. The apparatus of claim 9, wherein the specific winning treatment describes one or more user interface element properties associated with a user interface of the mobile application.

13. The apparatus of claim 9, wherein the specific winning treatment describes one or more advertisement format properties associated with a user interface of the mobile application.

14. The apparatus of claim 9, wherein the determination module is further configured to:
receive test result information associated with the specific A/B test from an experimentation web service;
determine the specific winning treatment for the specific A/B test, based on the test result information; and
generate the winning treatment information describing the specific winning treatment for the specific A/B test.

15. The apparatus of claim 9, wherein the determination module is further configured to:
receiving an activation detection signal transmitted by at least one of the mobile application installed on the mobile device and a mobile operating system installed on the mobile device.

16. A non-transitory machine-readable storage medium having embodied thereon instructions executable by one or more machines to perform operations comprising:
detecting that a user of a mobile device has activated a version of a mobile application installed on the mobile device, the mobile application being pre-programmed with a plurality of candidate treatments associated with one or more features of the mobile application;
accessing a database storing winning treatment information describing one or more winning treatments for one or more A/B tests, each of the one or more A/B tests being associated with a particular version of a particular mobile application;
determining, based on the winning treatment information, a specific winning treatment for a specific A/B test associated with the version of the mobile application installed on the mobile device; and
instructing the mobile application to select the specific winning treatment from among the plurality of candidate treatments pre-programmed into the mobile application and to perform operations based on the specific winning treatment.

17. The storage medium of claim 16, wherein the plurality of candidate treatments are pre-programmed into programming code associated with the mobile application.

18. The storage medium of claim 17, wherein the instructing comprises:
transmitting a request to the mobile application to select the winning treatment from among the plurality of candidate treatments pre-programmed into the mobile application and to perform operations based on the winning treatment.

19. The storage medium of claim 16, wherein the specific winning treatment describes one or more user interface element properties associated with a user interface of the mobile application.

20. The storage medium of claim 16, wherein the specific winning treatment describes one or more advertisement format properties associated with a user interface of the mobile application.
